(19) United States
(12) Patent Application Publication
(10) Pub. No.: US 2018/0359303 A1
(43) Pub. Date: Dec. 13, 2018

(54) DATA PROCESSING APPARATUS, DATA PROCESSING METHOD, AND COMPUTER READABLE MEDIUM

(71) Applicant: Mitsubishi Electric Corporation, Tokyo (JP)

(72) Inventor: Takahiro HIRAMATSU, Tokyo (JP)

(73) Assignee: Mitsubishi Electric Corporation, Tokyo (JP)

(21) Appl. No.: 15/525,699

(22) PCT Filed: Mar. 5, 2015
(86) PCT No.: PCT/JP2015/056556

§ 371 Date: May 10, 2017

(51) Int. Cl. H04L 29/06; H04N 7/18; H04N 5/232; H04N 19/172; H04N 19/159; H04N 19/114

(52) U.S. Cl. CPC H04L 65/608; H04N 7/18; H04N 19/114; H04N 19/172; H04N 19/159; H04N 5/23206

(57) ABSTRACT

A reception unit (301) receives a plurality of pieces of I-frame data and a plurality of pieces of P-frame data in which time stamps are set. A time acquisition unit (302) acquires a reception time of each I-frame data. A video storage unit (303) stores the plurality of pieces of I-frame data and the plurality of pieces of P-frame data. A time calculation unit (304) calculates a readout time of the I-frame data from the video storage unit (303) based on a reception time of the I-frame data to be read out, a reception time of preceding I-frame data being I-frame data that precedes the I-frame data to be read out, and a readout time of the preceding I-frame data, and calculates a readout time of the P-frame data from the video storage unit (303) based on a time stamp of the P-frame data to be read out. A data readout unit (305) reads out the I-frame data to be read out and the P-frame data to be read out at the times calculated by the time calculation unit (304).

### TECHNICAL FIELD

The present invention relates to a technique for controlling a readout time of video data.

### BACKGROUND ART

Assume a case where a monitor camera transmits the video data to a recorder using a RTP (Real-time Transport Protocol) protocol defined in the RFC (Request for Comments) 3550.

In this case, in the recorder, a time stamp included in a RTP header is synchronized, using a SR (Sender Report) of a RTCP (Real-time Transport Control Protocol) packet, with a NTP (Network Time Protocol) time stamp provided in the monitor camera.

If the monitor camera that transmits the video data according to the above method does not have a battery for time backup, the monitor camera cannot keep the correct time at power off.

Therefore, when the monitor camera is powered off, a time is acquired from the outside using a NTP protocol or the like after power on.

However, the monitor camera needs a predetermined time interval to acquire the time.

When the monitor camera performs an image capturing and transmits the captured video data to the recorder even until the monitor camera can acquire the time from the outside, a value of the NTP time stamp associated with the RTP time stamp by the SR of the RTCP is incorrect until the time is acquired.

Therefore, the recorder records the video data with the incorrect NTP time stamp and redistributes the video data at an incorrect timing on an occasion of redistributing the video data.

In order to avoid this problem, it is considered that the recorder records a reception time of the video data of each frame without using the RTCP, and the recorded reception time is used as timing information when redistributing the video data.

However, in a predictive coding system such as H.264, a size of I (Intra-coded)-frame data is larger than that of other types of frame data.

Therefore, due to a factor such as a bandwidth between the monitor camera and the recorder, it takes longer to transmit the I-frame data than to transmit the other types of frame data.

As a result of this, a reception interval between frame data that immediately precedes the I-frame data and the I-frame data, and a reception interval between the I-frame data and frame data that immediately proceeds the I-frame data are longer than a frame interval at the time of capturing image, so that the I-frame data and frame data that follows the I-frame data may displace.

This displacement is accumulated each time the I-frame data is received.

Then, for example, when the frame data is read out for redistributing in accordance with a reception time of frame data, a difference between a readout timing and an image capturing timing becomes wider along with an appearance of the I-frame data.

Patent Literature 1 describes a technique for performing a clock reproduction using a PLL (Phase Locked Loop) when a RTP transmits data that requires exact clock synchronization such as MPEG2-TS (Motion Picture Experts Group 2 Transport Stream).

### CITATION LIST

### Patent Literature

Patent Literature: JP 2009-23937 A

### SUMMARY OF INVENTION

### Technical Problem

As described above, a problem arises in a method in which the frame data is read out in accordance with the reception time of the frame data at the recorder, when the size of the I-frame data is larger than that of the other types of frame data, the difference between the readout timing and the image capturing timing becomes wider along with the appearance of the I-frame data.

Further, in the technique of Patent Literature 1, the PLL which is specialized hardware is necessary.

The present invention mainly aims to solve a problem described above. The primary purpose of the present invention is, even when a size of I-frame data is larger than that of other types of frame data, to synchronize a readout time of frame data of each frame with an image capturing time without using specialized hardware.

### Solution to Problem

A data processing apparatus according to the present invention includes:

a reception unit to receive a plurality of pieces of I (Intra-coded)-frame data and a plurality of pieces of P (Predicted)-frame data in which a time stamp is set in each frame data;

a time acquisition unit to acquire a reception time of each I-frame data received by the reception unit;

a video storage unit to store the plurality of pieces of I-frame data and the plurality of pieces of P-frame data received by the reception unit;

a time calculation unit to calculate a readout time of I-frame data from the video storage unit based on a reception time of the I-frame data to be read out, a reception time of preceding I-frame data being I-frame data that precedes the I-frame data to be read out, and a readout time of the preceding I-frame data, and calculate a readout time of P-frame data from the video storage unit based on a time stamp of the P-frame data to be read out; and

a data readout unit to read out from the video storage unit the I-frame data to be read out and the P-frame data to be read out each at the time calculated by the time calculation unit.

### Advantageous Effects of Invention

In the present invention, a readout time of I-frame data is calculated based on a reception time of the I-frame data to be read out, a reception time of preceding I-frame data, and a readout time of the preceding I-frame data, so that a displacement of the I-frame data at the reception time can be adjusted.

Therefore, according to the present invention, even when a size of the I-frame data is larger than that of other types of frame data, a readout time of frame data of each frame can be synchronized with an image capturing time without using specialized hardware.

### BRIEF DESCRIPTION OF DRAWINGS

FIG. 1 is a diagram illustrating a system configuration example according to a first embodiment.

FIG. 2 is a flowchart diagram illustrating an operation example of a data processing apparatus according to the first embodiment.

FIG. 3 is a flowchart diagram illustrating an operation example of the data processing apparatus according to the first embodiment.

FIG. 4 is a diagram illustrating an example of reception times and readout times according to the first embodiment.

FIG. 5 is a diagram illustrating a hardware configuration example of the data processing apparatus according to the first embodiment.

### DESCRIPTION OF EMBODIMENTS

### First Embodiment

***Description of Configuration***

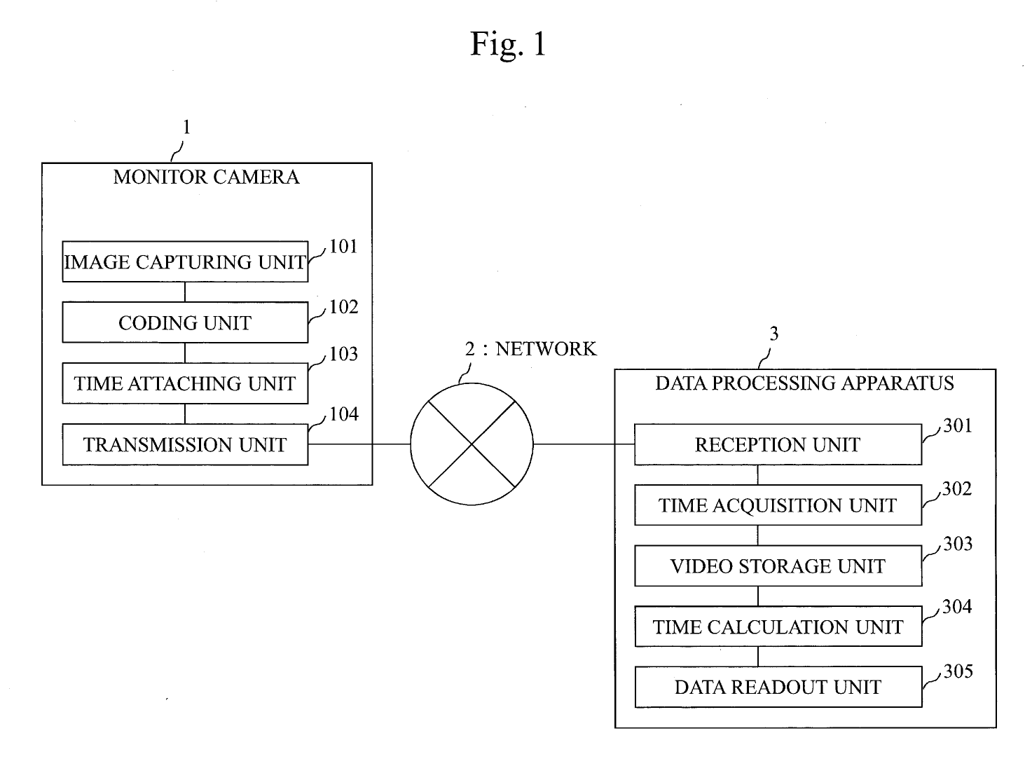

FIG. 1 illustrates a system configuration example according to the present embodiment.

In FIG. 1, a monitor camera 1 captures an image of an image capturing target (for example, an area to be monitored), and transmits video data of the image capturing target.

A network 2 is a network used for transmitting the video data, and is a LAN (Local Area Network), the Internet, or the like.

A data processing apparatus 3 receives the video data which is from the monitor camera 1, and stores the received video data.

The data processing apparatus 3 is, for example, a monitor recorder.

Note that, FIG. 1 illustrates only one monitor camera 1, but there may exist a plurality of monitor cameras 1.

The captured video data from the monitor camera 1 includes a plurality of pieces of I (Intra-coded)-frame data, a plurality of pieces of B (Bi-directional Predicted)-frame data, and a plurality of pieces of P (Predicted)-frame data.

As described above, a size of the I-frame data is larger than those of the B-frame data and the P-frame data.

Therefore, it takes longer to transmit the I-frame data than to transmit the B-frame data and the P-frame data.

Further, as described below, a time stamp is set in each frame data.

In the monitor camera 1, an image capturing unit 101 captures the image of the image capturing target.

A coding unit 102 codes video captured by the image capturing unit 101.

A time attaching unit 103 attaches the time stamp on data (frame data) obtained by the coding performed by the coding unit 102.

A transmission unit 104 transmits the frame data (the plurality of pieces of I-frame data, the plurality of pieces of B-frame data, and the plurality of pieces of P-frame data) via the network 2 to the data processing apparatus 3.

In the data processing apparatus 3, a reception unit 301 receives the frame data (the plurality of pieces of I-frame data, the plurality of pieces of B-frame data, and the plurality of pieces of P-frame data) transmitted from the monitor camera 1.

A time acquisition unit 302 acquires a reception time at which the reception unit 301 receives the I-frame data.

A video storage unit 303 is a storage area for storing the plurality of pieces of I-frame data, the plurality of pieces of B-frame data, and the plurality of pieces of P-frame data received by the reception unit 301.

Further, the video storage unit 303 also stores the reception time of the I-frame data acquired by the time acquisition unit 302.

A time calculation unit 304 calculates a readout time at which a data readout unit 305 described below reads out each frame data from the video storage unit 303.

The time calculation unit 304 calculates a readout time of the I-frame data from the video storage unit 303 based on the reception time of the I-frame data to be read out, a reception time of preceding I-frame data being I-frame data that precedes the I-frame data to be read out, a readout time of the preceding I-frame data.

For example, the time calculation unit 304 calculates the readout time of the I-frame data from the video storage unit 303 based on a deference between the reception time of the I-frame data to be read out and a reception time of immediately preceding I-frame data being I-frame data that immediately precedes the I-frame data to be read out, and a readout time of the immediately preceding I-frame data.

Further, the time calculation unit 304 calculates a readout time of the B-frame data from the video storage unit 303 based on a time stamp of the B-frame data to be read out.

For example, the time calculation unit 304 calculates the readout time of the B-frame data from the video storage unit 303 based on a difference between the time stamp of the B-frame data to be read out and a time stamp of immediately preceding frame data being frame data that immediately precedes the B-frame data to be read out, and a readout time of the immediately preceding frame data.

Further, the time calculation unit 304 calculates a readout time of the P-frame data from the video storage unit 303 based on a time stamp of the P-frame data to be read out.

For example, the time calculation unit 304 calculates the readout time of the P-frame data from the video storage unit 303 based on a difference between the time stamp of the P-frame data to be read out and a time stamp of immediately preceding frame data being frame data that immediately precedes the P-frame data to be read out, and a readout time of the immediately preceding frame data.

The data readout unit 305 reads out from the video storage unit 303 the I-frame data to be read out, the B-frame data to be read out, and the P-frame data to be read out each at the time calculated by the time calculation unit 304.

The data readout unit 305 reproduces the video captured by the monitor camera 1 using each read out frame data.

Otherwise, the data readout unit 305 redistributes each read out frame data to an external device.

***Description of Operation***

Nextly, an operation example of the present embodiment will be described.

Firstly, an operation example of the monitor camera 1 will be described.

In the monitor camera 1, the image capturing unit 101 captures the image of the image capturing target.

The coding unit 102 codes the video captured by the image capturing unit 10.

When the transmission unit 104 transmits the frame data obtained by the coding performed by the coding unit 102 in a format of a RTP packet, the time attaching unit 103 inserts the time stamp into a RTP header.

Assume that a frequency of the time stamp is 90000 Hz, a value of the time stamp increases by 3000 for each frame if the video is 30 frames per second.

The transmission unit 104 transmits via the network 2 to the data processing apparatus 3 the RTP packet in which the time stamp is set in the RTP header.

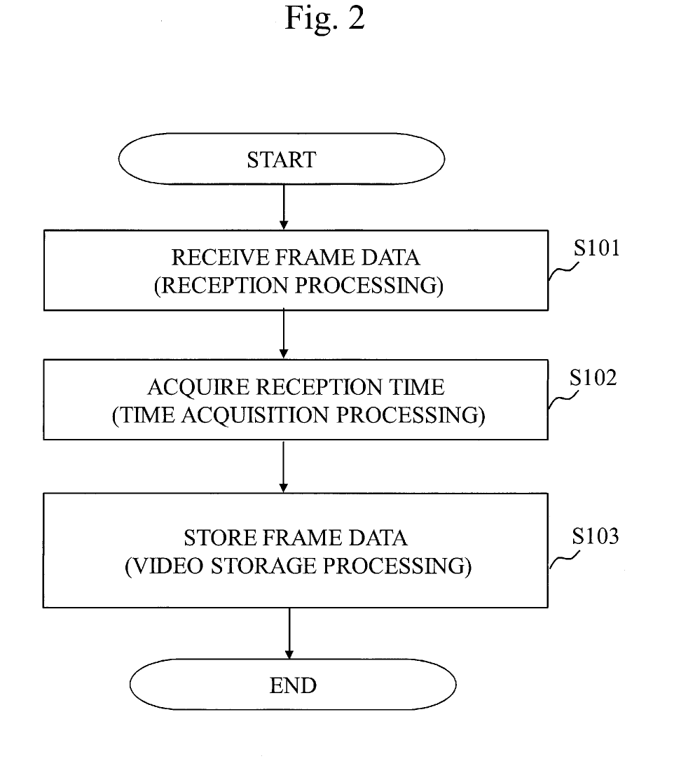

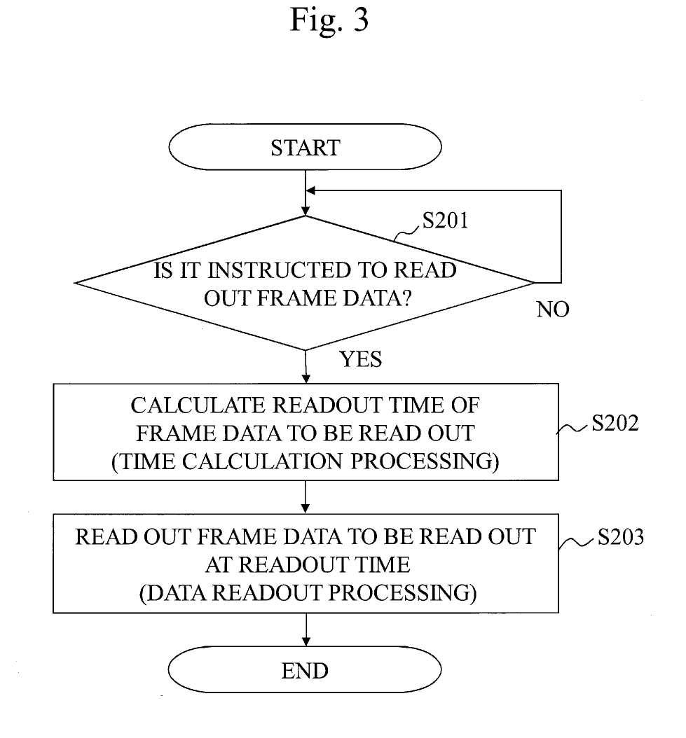

Nextly, with reference to FIGS. 2 and 3, an operation example of the data processing apparatus 3 will be described.

FIG. 2 illustrates reception processing, time acquisition processing, and video storage processing of the data processing apparatus 3.

FIG. 3 illustrates time calculation processing and data readout processing of the data processing apparatus 3.

The procedures illustrated in FIGS. 2 and 3 correspond to the processing procedures of a data processing method and a data processing program.

In FIG. 2, the reception unit 301 of the data processing apparatus 3 receives the RTP packet transmitted from the transmission unit 104 of the monitor camera 1 (S101) (reception processing).

As described above, the RTP packet includes the frame data and the time stamp.

Nextly, the time acquisition unit 302 acquires the reception time at which the reception unit 301 receives the I-frame data (S102) (time acquisition processing).

When one piece of I-frame data is divided into a plurality of RTP packets and the plurality of RTP packets are transmitted, the time acquisition unit 302 acquires a reception time of a head packet from among the plurality of RTP packets.

That is, the time acquisition unit 302 acquires a time at which the reception unit 301 starts to receive each I-frame data as the reception time of each I-frame data.

Here, the time acquisition unit 302 acquires only the reception time of the I-frame data, but the time acquisition unit 302 may acquire the reception time of the B-frame data and the reception time of the P-frame data.

The video storage unit 303 stores each frame data and each time stamp received by the reception unit 301 (S103) (video storage processing).

Further, the video storage unit 303 stores the reception time acquired by the time acquisition unit 302 by associating it with the I-frame data.

When it is instructed by a user of the data processing apparatus 3 to read out the frame data after receiving the RTP packet or concurrently with receiving the RTP packet (YES at S201 in FIG. 3), the time calculation unit 304 calculates the readout time of the frame data to be read out (S202) (time calculation processing).

The details of methods for calculating readout times will be described below. As described above, a method for calculating the readout time of the I-frame data is different from a method for calculating the readout time of the B-frame data, and a method for calculating the readout time of the P-frame data.

The data readout unit 305 reads out from the video storage unit 303 the I-frame data to be read out, the B-frame data to be read out, and the P-frame data to be read out each at the time calculated by the time calculation unit 304 (S203) (data readout processing).

Note that, S203 is performed after S202 in FIG. 3, but S202 and S203 may be performed concurrently.

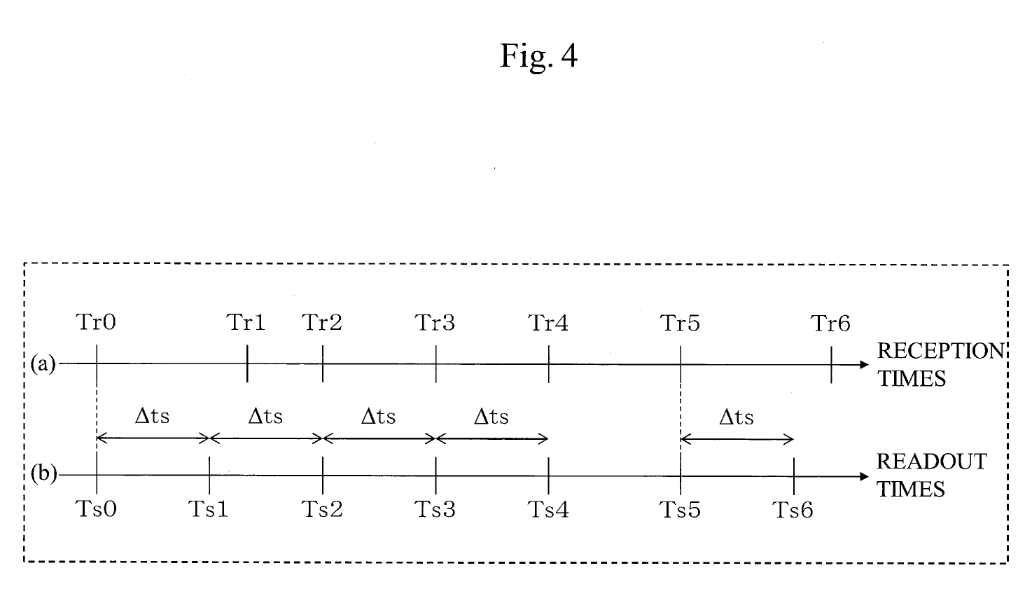

Nextly, with reference to FIG. 4, the details of the method for calculating the readout time will be described.

FIG. 4 illustrates time progresses from the left to the right.

Note that, (a) in FIG. 4 represents reception times, and (b) in FIG. 4 represents readout times.

A time Tr0 to a time Tr6 represent times at which 0th to 6th frame data are received.

The 0th frame data and the 5th frame data are I-frame data.

The 1st frame data to the 4th frame data and the 6th frame data are P-frame data or B-frame data.

A time Ts0 to a time Ts6 represent readout times of the 0th to the 6th frame data.

Further, a value Δts is a constant value and equals to a difference value 3000 between time stamps of preceding and following frame data. This equals to 1/30 second.

Assume a case where it is instructed by the user of the data processing apparatus 3 to read out frame data starting from the 0th frame data.

The time Ts0 is the time at which it is instructed by the user to read out the frame data.

The readout time calculation unit 304 specifies the time Ts0 as the readout time of the 0th frame data, and the data readout unit 305 reads out the 0th frame data from the video storage unit 303 at the time Ts0.

The time calculation unit 304 calculates the readout time of the 1st frame data by Ts1=Ts0+Δts.

That is, the time calculation unit 304 calculates the readout time Ts1, without referring to the reception time Tr1, by adding the difference Δts of the time stamps to the readout time Ts0 of the 0th frame data being immediately preceding frame data.

Similarly, the time calculation unit 304 calculates the readout time Ts2 of the 2nd frame data, the readout time Ts3 of the 3rd frame data, and the readout time Ts4 of the 4th frame data as follows:

Ts2=Ts1+Δts

Ts3=Ts2+Δts

Ts4=Ts3+Δts

Nextly, since the 5th frame data is the I-frame data, the time calculation unit 304 calculates the readout time Ts5 of the 5th frame by Ts5=Ts0+Tr5−Tr0.

That is, the time calculation unit 304 calculates the readout time Ts5, without referring to the readout time Ts4, by adding a difference between the reception time Tr0 of the 0th frame data being I-frame data that immediately precedes the 5^{th} frame data and the reception time Tr0 of the 5th frame data, to the readout time Ts0.

Nextly, the time calculation unit 304 calculates the transmission time Ts6 of the 6th frame data by Ts6−Ts5+Δts.

That is, the time calculation unit 304 calculate the readout time Ts6, without referring to the reception time Tr6, by adding the difference Δts between the time stamps to the readout time Ts5 of the 5th frame data being immediately preceding frame data.

Although it is not illustrated in FIG. 4, when 7th to 9th frame data is B-frame data or P-frame data and 10th frame data is I-frame data, the time calculation unit 304 calculates a readout time Ts10 of the 10th frame data by Ts10=Ts5+Tr10-Tr5.

That is, the time calculation unit 304 calculates the readout time Ts10, without referring to a 9th readout time Ts9, by adding a difference between the reception time Tr5 of the 5th frame data being I-frame data that immediately precedes the 10th frame data and the reception time Tr10 of the 10th frame data, to the readout time Ts5.

Note that, a method for calculating the readout times of the 7th to the 9th frame data is the same as the method for calculating the readout times of the 1st to the 4th frame data.

In the above, the time calculation unit 304 calculates the readout time of the I-frame data based on the readout time of the immediately preceding I-frame data.

However, the time calculation unit 304 may calculate the readout time of the I-frame data to be read out based on a readout time of I-frame data that is not the immediately preceding I-frame data but I-frame data that precedes the I-frame data to be read out.

For example, if a readout time of I-frame data preceding by 5 frames to the 0th frame data has already been calculated, the time calculation unit 304 may calculate the readout time Ts5 of the 5th frame data based on the readout time of the I-frame data preceding by 5 frames to the 0th frame data.

Here, assume that a reception time of the I-frame data preceding by 5 frames to the 0th frame data is Trm5, and the readout time of the I-frame data preceding by 5 frames to the 0th frame data is Tsm5.

In this case, the readout time Ts5 of the 5th frame data may be calculated by Ts5=Tsm5+Trm5−Tr5.

Further, in the above, the time calculation unit 304 calculates the readout time Ts5 by Ts5=Ts0+Tr5−Tr0. As a result, Ts5−Ts4 may have a significantly different value from Δts.

In such a case, the readout time of the I-frame data may be adjusted using a reception interval of past I-frame data.

For example, assume that the reception time of the I-frame data preceding by 5 frames to the 0th frame data is Trm5, and a reception time of I-frame data preceding by 10 frames to the 0th frame data is Trm10.

The time calculation unit 304 may, for example, calculate the readout time Ts5 by Ts5=Ts0+(Tr5−Tr0)×0.5+(Tr0−Trm5)×0.3+(Trm5−Trm10)×0.2.

As just described, the time calculation unit 304 may calculate the readout time of the I-frame data from the video storage unit 303 based on a difference between the reception time of the I-frame data to be read out and the reception time of the immediately preceding I-frame data being I-frame data that immediately precedes the I-frame data to be read out, a difference between reception times of a plurality of pieces of I-frame data that precedes the immediately preceding I-frame data, and the readout time of the immediately preceding I-frame data.

Further, the time calculation unit 304 may change the parameter (0.5,0.3,0.2) used in the above formula, or may calculate the readout time Ts5 using a calculation formula different from the above formula.

Further, in the above, the data processing apparatus 3 receives the I-frame data, the B-frame data, and the P-frame data from the monitor camera. However, the present embodiment is applicable to a case where the data processing apparatus 3 receives only the I-frame data and the B-frame data from the monitor camera 1.

***Description of Effect***

According to the present embodiment, even when the monitor camera 1 does not have the absolute time including a western calendar date, the data processing apparatus 3 can read frame data of each frame by synchronizing it with the image capturing timing.

Further, even when there is a difference in speed between a time clock source mounted on the monitor camera 1 and not illustrated and a time clock source mounted on the data processing apparatus 3 and not illustrated, it is possible to reproduce video data or redistribute the video data without failure.

### Second Embodiment

In the first embodiment, the method for calculating the readout time of the P-frame data is the same as the method for calculating the readout time of the B-frame data.

In the present embodiment, the readout time of the P-frame data is calculated in accordance with the method for calculating the readout time of the I-frame data indicated in the first embodiment.

In the present embodiment, a system configuration example is also as illustrated in FIG. 1.

Further, an operation of the data processing apparatus 3 is also as illustrated in FIGS. 2 and 3.

However, in the present embodiment, the time acquisition unit 302 acquires, at S102 in FIG. 2, the reception time at which the reception unit 301 receives the I-frame data and also acquires the reception time at which the reception unit 301 receives the P-frame data.

When one piece of P-frame data is divided into a plurality of RTP packets and the plurality of RTP packets are transmitted, the time acquisition unit 302 acquires a reception time of a head packet from among the plurality of RTP packets.

That is, the time acquisition unit 302 acquires a time at which the reception unit 301 starts to receive each P-frame data as the reception time of each P-frame data.

Further, the video storage unit 303 also stores the reception time of the P-frame data at S103 in FIG. 2.

Furthermore, the time calculation unit 304 calculates, at S202 in FIG. 3, the readout time of the P-frame data in accordance with the method for calculating the readout time of the I-frame data indicated in the first embodiment.

More specifically, the time calculation unit 304 calculates the readout time of the P-frame data based on the reception time of the P-frame data to be read out, a reception time of preceding I/P-frame data being I-frame data or P-frame data that precedes the P-frame data to be read out, and a readout time of the preceding I/P-frame data.

Further, in the first embodiment, the time calculation unit 304 calculates the readout time of the I-frame data based on the readout time of the preceding I-frame data, but in the present embodiment, the time calculation unit 304 may calculate the readout time of the I-frame data based on the readout time of the preceding P-frame data.

In the below, with reference to FIG. 4, a method for calculating the readout time of the I-frame data and a method for calculating the readout time of the P-frame data according to the present embodiment will be described.

In the present embodiment, assume a case where the 0th frame data is I-frame data and the 5th frame data is P-frame data in FIG. 4.

Further, the 1st to the 4th frame data and the 6th frame data are all B-frame data.

The time calculation unit 304 calculates the readout times of the 0th to 4th frame data using the same method as the first embodiment.

Further, the time calculation unit 304 calculates the readout time Ts5 of the 5th frame data (P-frame data) by Ts5=Ts0+Tr5−Tr0 as in the first embodiment.

That is, the time calculation unit 304 calculates the readout time Ts5, without referring to the readout time Ts4, by adding a difference between the reception time Tr0 of the 0th frame data being I-frame data that immediately precedes the 5th frame data and the reception time Tr0 of the 5th frame data, to the readout time Ts0.

Nextly, the time calculation unit 304 calculates the transmission time Ts6 of the 6th frame data using the same method as the first embodiment.

Although it is not illustrated in FIG. 4, when the 7th to the 9th frame data is B-frame data or P-frame data and the 10th frame data is I-frame data, the time calculation unit 304 calculates the readout time Ts10 of the 10th frame data by Ts10=Ts5+Tr10−Tr5.

That is, the time calculation unit 304 calculates the readout time Ts10, without referring to the 9th readout time Ts9, by adding a difference between the reception time Tr5 of the 5th frame data being P-frame data that immediately precedes the 10th frame data and the reception time Tr10 of the 10th frame data, to the readout time Ts5.

Note that, a method for calculating the readout times of the 7th to the 9th frame data is the same as the first embodiment.

In the above, the time calculation unit 304 calculates the readout time of the I-frame data (or the P-frame data) based on a readout time of immediately preceding I-frame data (or the P-frame data).

However, the time calculation unit 304 may calculate the readout time of the I-frame data (or the P-frame data) to be read out based on a readout time of I-frame data (or the P-frame data) that is not the immediately preceding I-frame data (or the P-frame data) but I-frame data (or the P-frame data) that precedes the I-frame data (or the P-frame data) to be read out.

For example, if a readout time of I-frame data (or the P-frame data) preceding by 5 frames to the 0th frame data has already been calculated, the time calculation unit 304 may calculate the readout time Ts5 of the 5th frame data based on the readout time of the I-frame data (or the P-frame data) preceding by 5 frames to the 0th frame data.

Here, assume that a reception time of the I-frame data (or the P-frame data) preceding by 5 frames to the 0th frame data is Trm5, and the readout time of the I-frame data (or the P-frame data) preceding by 5 frames to the 0th frame data is Tsm5.

In this case, the readout time Ts5 of the 5th frame data may be calculated by Ts5=Tsm5+Trm5−Tr5.

Further, the time calculation unit 304 may calculate the readout time of the I-frame data (or the P-frame data) using another calculation method indicated in the first embodiment.

In the present embodiment, assume that the reception time of the P-frame data preceding by 5 frames to the 0th frame data is Trm5, and the reception time of the I-frame data preceding by 10 frames to the 0th frame data is Trm10.

The time calculation unit 304 may, for example, calculate the readout time Ts5 of the P-frame data (or the I-frame data) being the 5th frame data by Ts5=Ts0+(Tr5−Tr0)×0.5+(Tr0−Trm5)×0.3+(Trm5−Trm10)×0.2.

As just described, the time calculation unit 304 may calculate the readout time of the I-frame data (or the P-frame data) from the video storage unit 303 based on a difference between the reception time of the I-frame data (or the P-frame data) to be read out and a reception time of the immediately preceding I/P-frame data being I-frame data or P-frame data that immediately precedes the I-frame data (or the P-frame data) to be read out, any one of a difference between reception times of a plurality of pieces of I-frame data that precedes the immediately preceding I/P-frame data, a difference between reception times of a plurality of pieces of P-frame data that precedes the immediately preceding I/P-frame data, and a difference between reception times of I-frame data and P-frame data that precede the immediately preceding I/P-frame data, and the readout time of the immediately preceding I/P-frame data.

That is, in the example described above, if the frame data preceding by 5 frames to the 0th frame data is I-frame data, and the frame data preceding 10 frames to the 0th frame data is I-frame data, the time calculation unit 304 uses a difference between the reception times of these two pieces of I-frame data.

Further, if the frame data preceding by 5 frames to the 0th frame data is P-frame data, and the frame data preceding 10 frames to the 0th frame data is P-frame data, the time calculation unit 304 uses a difference between the reception times of these two pieces of P-frame data.

Further, if the frame data preceding by 5 frames to the 0th frame data is I-frame data (or P-frame data), and the frame data preceding 10 frames to the 0th frame data is P-frame data (or I-frame data), the time calculation unit 304 uses a difference between the reception times of these I-frame data and P-frame data.

Further, the time calculation unit 304 may change the parameter (0.5,0.3,0.2) used in the above formula, or may calculate the readout time Ts5 using a calculation formula different from the above formula.

As described above, according to the present embodiment, even when a size of the P-frame data is also significantly larger than that of the B-frame data, a readout time of frame data of each frame can be synchronized with an image capturing time without using specialized hardware.

The embodiments of the present invention have been described above. The present invention is not limited to these embodiments, and various modifications are possible as appropriate.

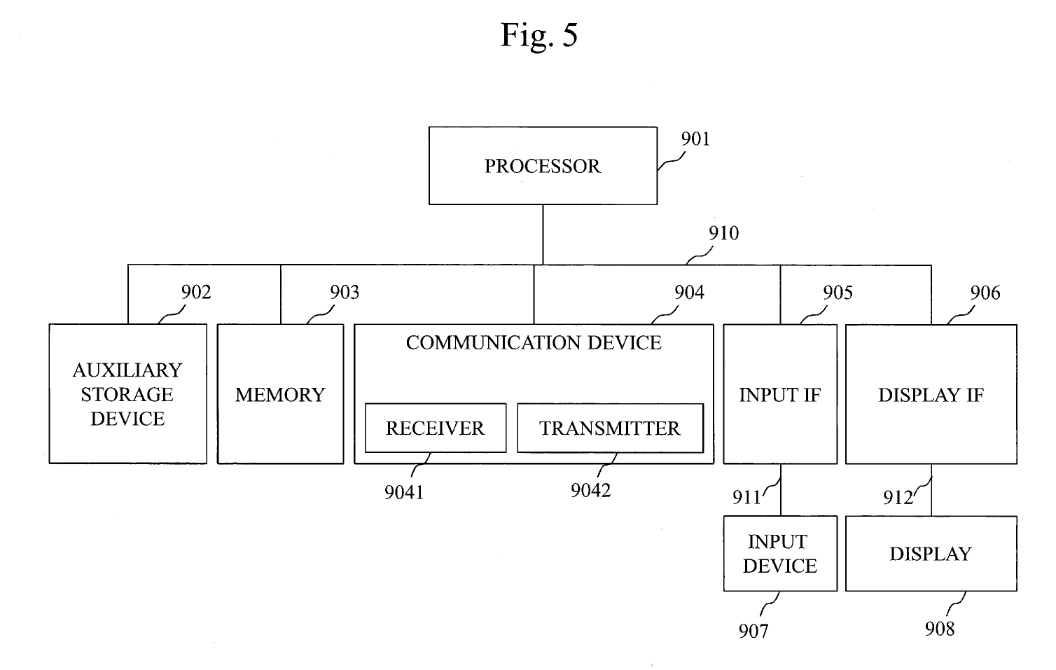

Lastly, a hardware configuration example of the data processing apparatus 3 will be described with reference to FIG. 5.

The data processing apparatus 3 is a computer.

The data processing apparatus 3 includes hardware such as a processor 901, an auxiliary storage device 902, a memory 903, a communication device 904, an input interface 905, and a display interface 906.

The processor 901 is connected to any other hardware via a signal line 910, and controls these other hardware.

The input interface 905 is connected to an input device 907.

The display interface 906 is connected to a display 908.

The processor 901 is an IC (Integrated Circuit) to perform processing.

The processor 901 is, for example, a CPU (Central Processing Unit), a DSP (Digital Signal Processor), or a GPU (Graphics Processing Unit).

The auxiliary storage device 902 is, for example, a ROM (Read Only Memory), a flash memory, or a HDD (Hard Disk Drive).

The memory 903 is, for example, a RAM (Random Access Memory).

The video storage unit 303 illustrated in FIG. 1 is implemented by the memory 903 or the auxiliary storage device 902.

The communication device 904 includes a receiver 9041 to receive data and a transmitter 9042 to transmit data.

The communication device 904 is, for example, a communication chip or a NIC (Network Interface Card).

The input interface 905 is a port to which a cable 911 of the input device 907 is connected.

The input interface 905 is, for example, a USB (Universal Serial Bus) terminal.

The display interface 906 is a port to which a cable 912 of the display 908 is connected.

The display interface 906 is, for example, a USB terminal or a HDMI (registered trademark) (High Definition Multimedia Interface) terminal.

The input device 907 is, for example, a mouse, a keyboard, or a touch panel.

The display 908 is, for example, a LCD (Liquid Crystal Display).

In the auxiliary storage device 902, programs are stored by which functions of the reception unit 301, the time acquisition unit 302, the time calculation unit 304, and the data readout unit 305 (hereinafter, the reception unit 301, the time acquisition unit 302, the time calculation unit 304, and the data readout unit 305 are collectively described as “unit”) illustrated in FIG. 1 are implemented.

These programs are loaded into the memory 903, read into the processor 901, and executed by the processor 901.

Furthermore, the auxiliary storage device 902 also stores an OS (Operating System).

Then, at least a part of the OS is loaded into the memory 903, and the processor 901 executes the programs each of which implements the function of “unit” while executing the OS.

In FIG. 5, one processor 901 is illustrated, but the data processing apparatus 3 may include a plurality of processors 901.

Then, the plurality of processors 901 may cooperatively execute the program which implements the function of “unit”.

Further, the memory 903, the auxiliary storage device 902, or a register or a cash memory in the processor 901 stores information, data, a signal value, and a variable value indicating the result of the processing of “unit”.

“Unit” may be provided using “circuitry”.

Further, “unit” may be read as a “circuit”, a “step”, a “procedure”, or a “process”.

The “circuit” and the “circuitry” are each a concept including not only the processor 901, but also other types of processing circuits such as a logic IC, a GA (Gate Array), an ASIC (Application Specific Integrated Circuit), or a FPGA (Field-Programmable Gate Array).

### REFERENCE SIGNS LIST

1: monitor camera; 2: network; 3: data processing apparatus; 101: image capturing unit; 102: coding unit; 103: time attaching unit; 104: transmission unit; 301: reception unit; 302: time acquisition unit; 303: video storage unit; 304: time calculation unit, and 305: data readout unit.

1.-14. (canceled)

15. A data processing apparatus comprising:
processing circuitry to:
receive a plurality of pieces of I (Intra-coded)-frame data and a plurality of pieces of P (Predicted)-frame data in which a time stamp is set in each frame data; and
acquire a reception time of each I-frame data received; and
a memory to store the plurality of pieces of I-frame data and the plurality of pieces of P-frame data received by the processing circuitry,
wherein the processing circuitry calculates a readout time of I-frame data from the memory based on a reception time of the I-frame data to be read out, a reception time of preceding I-frame data being I-frame data that precedes the I-frame data to be read out, and a readout time of the preceding I-frame data, and calculate a readout time of P-frame data from the memory based on a time stamp of the P-frame data to be read out, and
reads out from the memory the I-frame data to be read out and the P-frame data to be read out each at the time calculated.

16. The data processing apparatus according to claim 15,
wherein the processing circuitry receives a plurality of pieces of I-frame data, a plurality of pieces of P-frame data, and a plurality of pieces of B (Bi-directional Predicted)-frame data in which a time stamp is set in each frame data,
wherein the memory stores the plurality of pieces of I-frame data, the plurality of pieces of P-frame data, and the plurality pieces of B-frame data received by the processing circuitry, and
wherein the processing circuitry calculates a readout time of B-frame data from the memory based on a time stamp of the B-frame data to be read out, and
reads out from the memory the I-frame data to be read out, the P-frame data to be read out, and the B-frame data to be read out each at the time calculated.

17. The data processing apparatus according to claim 15,
wherein the processing circuitry receives a plurality of pieces of I-frame data, a plurality of pieces of P-frame data, and a plurality of pieces of B (Bi-directional Predicted)-frame data in which a time stamp is set in each frame data, and
acquires a reception time of each I-frame data and a reception time of each B-frame data received,
wherein the memory stores the plurality of pieces of I-frame data, the plurality of pieces of P-frame data, and the plurality pieces of B-frame data received by the processing circuitry, and
wherein the processing circuitry calculates a readout time of I-frame data from the memory based on a reception time of the I-frame data to be read out, a reception time of preceding I/P-frame data being I-frame data or P-frame data that precedes the I-frame data to be read out, and a readout time of the preceding I/P-frame data,
calculates a readout time of B-frame data from the memory based on a time stamp of the B-frame data to be read out,
calculates a readout time of P-frame data from the memory based on a reception time of the P-frame data to be read out, a reception time of the preceding I/P-frame data being I-frame data or P-frame data that precedes the P-frame data to be read out, and a readout time of the preceding I/P-frame data, and
reads out from the memory the I-frame data to be read out, the P-frame data to be read out, and the B-frame data to be read out each at the time calculated.

18. The data processing apparatus according to claim 15,
wherein the processing circuitry acquires a time at which the processing circuitry starts to receive each I-frame data as the reception time of each I-frame data.

19. The data processing apparatus according to claim 17,
wherein the processing circuitry acquires a time at which the processing circuitry starts to receive each I-frame data as the reception time of each I-frame data, and
acquires a time at which the processing circuitry starts to receive each P-frame data as the reception time of each P-frame data.

20. The data processing apparatus according to claim 15,
wherein the processing circuitry calculates the readout time of the I-frame data to be read out from the memory based on a difference between the reception time of the I-frame data to be read out and a reception time of immediately preceding I-frame data being I-frame data that immediately precedes the I-frame data to be read out, and a readout time of the immediately preceding I-frame data.

21. The data processing apparatus according to claim 15,
wherein the processing circuitry calculates the readout time of the I-frame data to be read out from the memory based on a difference between the reception time of the I-frame data to be read out and a reception time of immediately preceding I-frame data being I-frame data that immediately precedes the I-frame data to be read out, a difference between reception times of a plurality of pieces of I-frame data that precedes the immediately preceding I-frame data, and a readout time of the immediately preceding I-frame data.

22. The data processing apparatus according to claim 15,
wherein the processing circuitry calculates the readout time of the P-frame data to be read out from the memory based on a difference between the time stamp of the P-frame data to be read out and a time stamp of immediately preceding frame data being frame data that immediately precedes the P-frame data to be read out, and a readout time of the immediately preceding frame data.

23. The data processing apparatus according to claim 16,
wherein the processing circuitry calculates the readout time of the B-frame data to be read out from the memory based on a difference between the time stamp of the B-frame data to be read out and a time stamp of immediately preceding frame data being frame data that immediately precedes the B-frame data to be read out, and a readout time of the immediately preceding frame data.

24. The data processing apparatus according to claim 17,
wherein the processing circuitry calculates the readout time of the I-frame data to be read out from the memory based on a difference between the reception time of the I-frame data to be read out and a reception time of immediately preceding I/P-frame data being I-frame data or P-frame data that immediately precedes the I-frame data to be read out, and a readout time of the immediately preceding I/P-frame data, and
calculates the readout time of the P-frame data to be read out from the memory based on a difference between the reception time of the P-frame data to be read out and a reception time of immediately preceding I/P-frame data being I-frame data or P-frame data that immediately precedes the P-frame data to be read out, and a readout time of the immediately preceding I/P-frame data.

25. The data processing apparatus according to claim 17,
wherein the processing circuitry calculates the readout time of the I-frame data to be read out from the memory based on a difference between the reception time of the I-frame data to be read out and a reception time of immediately preceding I/P-frame data being I-frame data or P-frame data that immediately precedes the I-frame data to be read out, any one of a difference between reception times of a plurality of pieces of I-frame data that precedes the immediately preceding I/P-frame data, a difference between reception times of a plurality of pieces of P-frame data that precedes the immediately preceding I/P-frame data, and a difference between reception times of I-frame data and P-frame data that precede the immediately preceding I/P-frame data, and a readout time of the immediately preceding I/P-frame data, and
calculates the readout time of the P-frame data to be read out from the memory based on a difference between the reception time of the P-frame data to be read out and a reception time of immediately preceding I/P-frame data being I-frame data or P-frame data that immediately precedes the P-frame data to be read out, any one of a difference between reception times of a plurality of pieces of I-frame data that precedes the immediately preceding I/P-frame data, a difference between reception times of a plurality of pieces of P-frame data that precedes the immediately preceding I/P-frame data, and a difference between reception times of I-frame data and P-frame data that precede the immediately preceding I/P-frame data, and a readout time of the immediately preceding I/P-frame data.

26. The data processing apparatus according to claim 17,
wherein the processing circuitry calculates the readout time of the B-frame data to be read out from the memory based on a difference between the time stamp of the B-frame data to be read out and a time stamp of immediately preceding frame data being frame data that immediately precedes the B-frame data to be read out, and a readout time of the immediately preceding frame data.

27. A data processing method comprising:
receiving a plurality of pieces of I (Intra-coded)-frame data and a plurality of pieces of P (Predicted)-frame data in which a time stamp is set in each frame data;
acquiring a reception time of each I-frame data;
storing to a storage area the plurality of pieces of I-frame data received and the plurality of pieces of P-frame data received;
calculating a readout time of I-frame data from the storage area based on a reception time of the I-frame data to be read out, a reception time of preceding I-frame data being I-frame data that precedes the I-frame data to be read out, and a readout time of the preceding I-frame data, and calculating a readout time of P-frame data from the storage area based on a time stamp of the P-frame data to be read out; and
reading out from the storage area the I-frame data to be read out and the P-frame data to be read out each at the time calculated.

28. A non-transitory computer readable medium storing a data processing program to cause a computer to execute:
reception processing to receive a plurality of pieces of I (Intra-coded)-frame data and a plurality of pieces of P (Predicted)-frame data in which a time stamp is set in each frame data;
time acquisition processing to acquire a reception time of each I-frame data received by the reception processing;
video storage processing to store to a storage area the plurality of pieces of I-frame data and the plurality of pieces of P-frame data received by the reception processing;
time calculation processing to calculate a readout time of I-frame data from the storage area based on a reception time of the I-frame data to be read out, a reception time of preceding I-frame data being I-frame data that precedes the I-frame data to be read out, and a readout time of the preceding I-frame data, and calculate a readout time of P-frame data from the storage area based on a time stamp of the P-frame data to be read out; and
data readout processing to read out from the storage area the I-frame data to be read out and the P-frame data to be read out each at the time calculated by the time calculation processing.
